(19) United States
(12) Patent Application Publication
(10) Pub. No.: US 2004/0240747 A1
(43) Pub. Date: Dec. 2, 2004

(54) Detection and correction of red-eye features in digital images

(76) Inventors: Nick Jarman, Hampshire (GB); Richard Lafferty, Surrey (GB); Marion Archibald, Surrey (GB); Mike Stroud, Surrey (GB); Nigel Biggs, Surrey (GB); Daniel Normington, Surrey (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/416,368

(22) PCT Filed: Jan. 3, 2003
(86) PCT No.: PCT/GB03/00004

(30) Foreign Application Priority Data
Feb. 22, 2002 (GB) 0204191.1

(51) Int. Cl. G06K 9/40; G06K 9/46

(52) U.S. Cl. 382/274; 382/190

(57) ABSTRACT

A method of detecting red-eye features (1) in a digital image comprises identifying highlight regions (2) of the image having pixels with a substantially red hue and higher saturation and lightness values than pixels in the regions therearound. In addition, pupil regions (3) comprising two saturation peaks either side of a saturation trough may be identified. It is then determined whether each highlight or pupil region corresponds to part of a red-eye feature on the basis of further selection criteria, which may include determining whether there is an isolated, substantially circular area (43) of correctable pixels around a reference pixel. Correction of red-eye features involves reducing the lightness and/or saturation of some or all of the pixels in the red-eye feature.

This invention relates to the detection and correction of red-eye in digital images.

The phenomenon of red-eye in photographs is well-known. When a flash is used to illuminate a person (or animal), the light is often reflected directly from the subject's retina back into the camera. This causes the subject's eyes to appear red when the photograph is displayed or printed.

Photographs are increasingly stored as digital images, typically as arrays of pixels, where each pixel is normally represented by a 24-bit value. The colour of each pixel may be encoded within the 24-bit value as three 8-bit values representing the intensity of red, green and blue for that pixel. Alternatively, the array of pixels can be transformed so that the 24-bit value consists of three 8-bit values representing “hue”, “saturation” and “lightness”. Hue provides a “circular” scale defining the colour, so that 0 represents red, with the colour passing through green and blue as the value increases, back to red at 255. Saturation provides a measure (from 0 to 255) of the intensity of the colour identified by the hue. Lightness can be seen as a measure (from 0 to 255) of the amount of illumination. “Pure” colours have a lightness value half way between black (0) and white (255). For example pure red (having a red intensity of 255 and green and blue intensities of 0) has a hue of 0, a lightness of 128 and a saturation of 255. A lightness of 255 will lead to a “white” colour. Throughout this document, when values are given for “hue”, “saturation” and “lightness” they refer to the scales as defined in this paragraph.

By manipulation of these digital images it is possible to reduce the effects of red-eye. Software which performs this task is well known, and generally works by altering the pixels of a red-eye feature so that their red content is reduced—in other words so that their hue is rendered less red. Normally they are left as black or dark grey instead.

Most red-eye reduction software requires the centre and radius of each red-eye feature which is to be manipulated, and the simplest way to provide this information is for a user to select the central pixel of each red-eye feature and indicate the radius of the red part. This process can be performed for each red-eye feature, and the manipulation therefore has no effect on the rest of the image. However, this requires considerable input from the user, and it is difficult to pinpoint the precise centre of each red-eye feature, and to select the correct radius. Another common method is for the user to draw a box around the red area. This is rectangular, making it even more difficult to accurately mark the feature.

There is therefore a need to identify automatically areas of a digital image to which red-eye reduction should be applied, so that red-eye reduction can be applied only where it is needed, either without the intervention of the user or with minimal user intervention.

The present invention recognises that a typical red-eye feature is not simply a region of red pixels. A typical red-eye feature usually also includes a bright spot caused by reflection of the flashlight from the front of the eye. These bright spots are known as “highlights”. If highlights in the image can be located then red-eyes are much easier to identify automatically. Highlights are usually located near the centre of red-eye features, although sometimes they lie off-centre, and occasionally at the edge.

In the following description it will be understood that references to rows of pixels are intended to include columns of pixels, and that references to movement left and right along rows is intended to include movement up and down along columns. The definitions “left”, “right”, “up” and “down” depend entirely on the co-ordinate system used.

In accordance with one aspect of the present invention there is provided a method of detecting red-eye features in a digital image, comprising:

identifying highlight regions of the image having pixels with a substantially red hue and higher saturation and lightness values than pixels in the regions therearound; and

determining whether each highlight region corresponds to part of a red-eye feature on the basis of further selection criteria.

A “red” hue in this context may mean that the hue is above about 210 or below about 10.

This has the advantage that the saturation/lightness contrast between highlight regions and the area surrounding them is much more marked than the colour (or “hue”) contrast between the red part of a red-eye feature and the skin tones surrounding it. Furthermore, colour is encoded at a low resolution for many image compression formats such as JPEG. By using saturation, lightness and hue together to detect red-eyes it is easier to identify regions which might correspond to red-eye features.

Not all highlights will be clear, easily identifiable, bright spots measuring many pixels across in the centre of the subject's eye. In some cases, especially if the subject is some distance from the camera, the highlight may be only a few pixels, or even less than one pixel, across. In such cases, the whiteness of the highlight can dilute the red of the pupil. However, it is still possible to search for characteristic saturation and lightness “profiles” of such highlights.

In accordance with another aspect of the present invention there is provided a method of detecting red-eye features in a digital image, comprising:

identifying pupil regions in the image, a pupil region comprising:

a first saturation peak adjacent a first edge of the pupil region comprising one or more pixels having a higher saturation than pixels immediately outside the pupil region;

a second saturation peak adjacent a second edge of the pupil region comprising one or more pixels having a higher saturation than pixels immediately outside the pupil region; and

a saturation trough between the first and second saturation peaks, the saturation trough comprising one or more pixels having a lower saturation than the pixels in the first and second saturation peaks; and

determining whether each pupil region corresponds to part of a red-eye feature on the basis of further selection criteria.

The step of identifying a pupil region may include confirming that all of the pixels between a first peak pixel having the highest saturation in the first saturation peak and a second peak pixel having the highest saturation in the second saturation peak have a lower saturation than the higher of the saturations of the first and second peak pixels. This step may also include confirming that a pixel immediately outside the pupil region has a saturation value less than or equal to a predetermined value, preferably about 50.

Having identified the saturation profile of a pupil region, further checks may be made to see if it could correspond to a red-eye feature. The step of identifying a pupil region preferably includes confirming that a pixel in the first saturation peak has a saturation value higher than its lightness value, and confirming that a pixel in the second saturation peak has a saturation value higher than its lightness value. Preferably it is confirmed that a pixel immediately outside the pupil region has a saturation value lower than its lightness value. It may also be confirmed that a pixel in the saturation trough has a saturation value lower than its lightness value, and/or that a pixel in the saturation trough has a lightness value greater than or equal to a predetermined value, preferably about 100. A final check may include confirming that a pixel in the saturation trough has a hue greater than or equal to about 220 or less than or equal to about 10.

Some highlight profiles can be identified in two stages. In accordance with another aspect of the invention, there is provided a method of detecting red-eye features in a digital image, comprising:

identifying pupil regions in the image by searching for a row of pixels with a predetermined saturation profile, and confirming that selected pixels within that row have lightness values satisfying predetermined conditions; and

determining whether each pupil region corresponds to part of a red-eye feature on the basis of further selection criteria.

Yet further profiles can be identified initially from the pixels' lightness. In accordance with a yet further aspect of the invention there is provided a method of detecting red-eye features in a digital image, comprising:

identifying pupil regions in the image, a pupil region including a row of pixels comprising:

a first pixel having a lightness value lower than that of the pixel immediately to its left;

a second pixel having a lightness value higher than that of the pixel immediately to its left;

a third pixel having a lightness value lower than that of the pixel immediately to its left; and

a fourth pixel having a lightness value higher than that of the pixel immediately to its left;

wherein the first, second, third and fourth pixels are identified in that order when searching along the row of pixels from the left; and

determining whether each pupil region corresponds to part of a red-eye feature on the basis of further selection criteria.

Preferably the first pixel has a lightness value at least about 20 lower than that of the pixel immediately to its left, the second pixel has a lightness value at least about 30 higher than that of the pixel immediately to its left, the third pixel has a lightness value at least about 30 lower than that of the pixel immediately to its left, and the fourth pixel has a lightness value at least about 20 higher than that of the pixel immediately to its left.

In a further preferred embodiment, the row of pixels in the pupil region includes at least two pixels each having a saturation value differing by at least about 30 from that of the pixel immediately to its left, one of the at least two pixels having a higher saturation value than its left hand neighbour and another of the at least two pixels having a saturation value lower than its left hand neighbour. Preferably the pixel midway between the first pixel and the fourth pixel has a hue greater than about 220 or less than about 10.

It is convenient to identify a single pixel as a reference pixel for each identified highlight region or pupil region.

Although many of the identified highlight regions and/or pupil regions may result from red-eye, it is possible that other features may give rise to such regions, in which case red-eye reduction should not be carried out. Therefore further selection criteria should preferably be applied, including determining whether there is an isolated area of correctable pixels around the reference pixel, a pixel being classified as correctable if it satisfies conditions of hue, saturation and/or lightness which would enable a red-eye correction to be applied to that pixel. Preferably it is also determined whether the isolated area of correctable pixels is substantially circular.

A pixel may preferably be classified as correctable if its hue is greater than or equal to about 220 or less than or equal to about 10, if its saturation is greater than about 80, and/or if its lightness is less than about 200.

It will be appreciated that this further selection criteria may be applied to any feature, not just to those detected by searching for the highlight regions and pupil regions identified above. For example, a user may identify where on the image he thinks a red-eye feature can be found. According to another aspect of the invention, therefore, there is provided a method of determining whether there is a red-eye feature present around a reference pixel in the digital image, comprising determining whether there is an isolated, substantially circular area of correctable pixels around the reference pixel, a pixel being classified as correctable if it has a hue greater than or equal to about 220 or less than or equal to about 10, a saturation greater than about 80, and a lightness less than about 200.

The extent of the isolated area of correctable pixels is preferably identified. A circle having a diameter corresponding to the extent of the isolated area of correctable pixels may be identified so that it is determined that a red-eye feature is present only if more than a predetermined proportion, preferably 50%, of pixels falling within the circle are classified as correctable.

Preferably a score is allocated to each pixel in an array of pixels around the reference pixel, the score of a pixel being determined from the number of correctable pixels in the set of pixels including that pixel and the pixels immediately surrounding that pixel.

An edge pixel, being the first pixel having a score below a predetermined threshold found by searching along a row of pixels starting from the reference pixel, may be identified. If the score of the reference pixel is below the predetermined threshold, the search for an edge pixel need not begin until a pixel is found having a score above the predetermined threshold.

Following the location of the edge pixel, a second edge pixel may be identified by moving to an adjacent pixel in an adjacent row from the edge pixel, and then

moving in towards the column containing the reference pixel along the adjacent row if the adjacent pixel has a score below the threshold, until the second edge pixel is reached having a score above the threshold,

moving out away from the column containing the reference pixel along the adjacent row if the adjacent pixel has a score above the threshold, until the second edge pixel is reached having a score above the threshold.

Subsequent edge pixels are then preferably identified in subsequent rows so as to identify the left hand edge and right hand edge of the isolated area, until the left edge and right hand edge meet or the edge of the array is reached. If the edge of the array is reached it may be determined that no isolated area has been found.

Preferably the top and bottom rows and furthest left and furthest right columns containing at least one pixel in the isolated area are identified, and a circle is then identified having a diameter corresponding to the greater of the distance between the top and bottom rows and furthest left and furthest right columns, and a centre midway between the top and bottom rows and furthest left and furthest right columns. It may then be determined that a red-eye feature is present only if more than a predetermined proportion of the pixels falling within the circle are classified as correctable. The pixel at the centre of the circle is preferably defined as the central pixel of the red-eye feature.

In order to account for the fact that the same isolated area may be identified starting from different reference pixels, one of two or more similar isolated areas may be discounted as a red-eye feature if said two or more substantially similar isolated areas are identified from different reference pixels.

Since the area around a subject's eyes will almost always consist of his skin, are always Preferably it is determined whether a face region surrounding and including the isolated region of correctable pixels contains more than a predetermined proportion of pixels having hue, saturation and/or lightness corresponding to skin tones. The face region is preferably taken to be approximately three times the extent of the isolated region.

Preferably a red-eye feature is identified if more than about 70% of the pixels in the face region have hue greater than or equal to about 220 or less than or equal to about 30, and more than about 70% of the pixels in the face region have saturation less than or equal to about 160.

In accordance with another aspect there is provided a method of processing a digital image, including detecting a red-eye feature using any of the methods described above, and applying a correction to the red-eye feature detected. This may include reducing the saturation of some or all of the pixels in the red-eye feature.

Reducing the saturation of some or all of the pixels may include reducing the saturation of a pixel to a first level if the saturation of that pixel is above a second level, the second level being higher than the first level.

Correcting a red-eye feature may alternatively or in addition include reducing the lightness of some or all of the pixels in the red-eye feature.

Where a red-eye feature has been detected having an isolated area of correctable pixels which have been allocated a score as described above, the correction of the red-eye feature may include changing the lightness and/or saturation of each pixel in the isolated area of correctable pixels by a factor related to the score of that pixel. Alternatively, if a circle has been identified, the lightness and/or saturation of each pixel within the circle may be reduced by a factor related to the score of that pixel.

The invention also provides a digital image to which any of the methods described above have been applied, apparatus arranged to carry out the any of the methods described above, and a computer storage medium having stored thereon a program arranged when executed to carry out any of the methods described above.

Some preferred embodiments of the invention will now be described by way of example only and with reference to the accompanying drawings, in which:

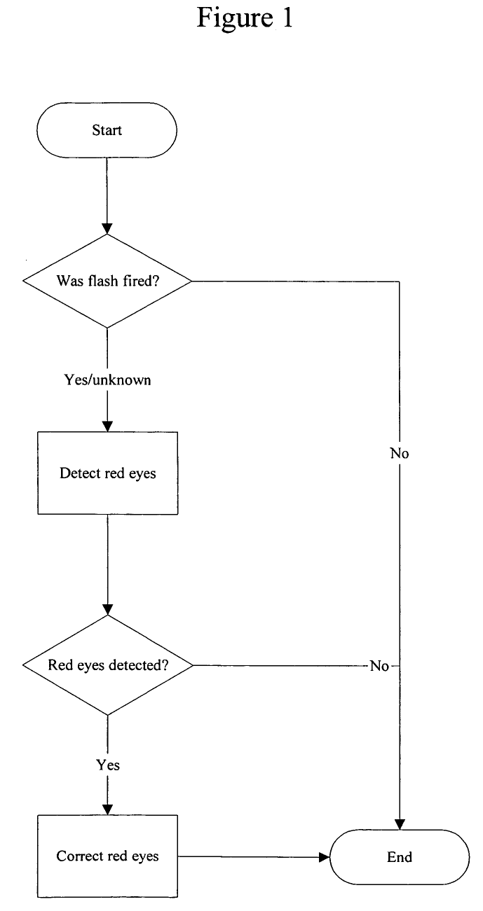

FIG. 1 is a flow diagram showing the detection and removal of red-eye features;

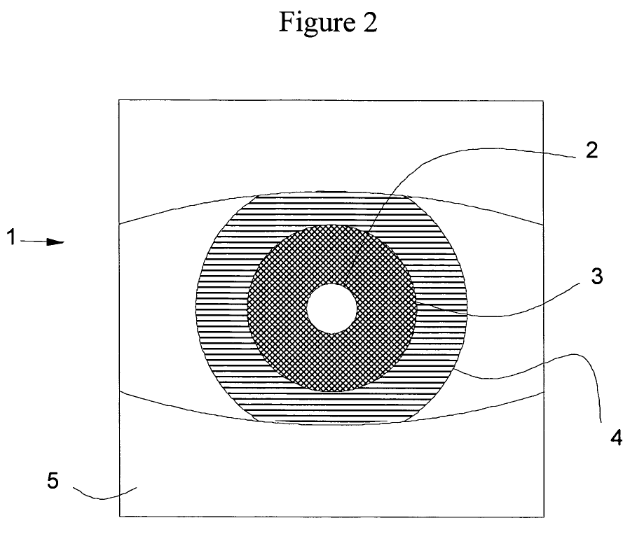

FIG. 2 is a schematic diagram showing a typical red-eye feature;

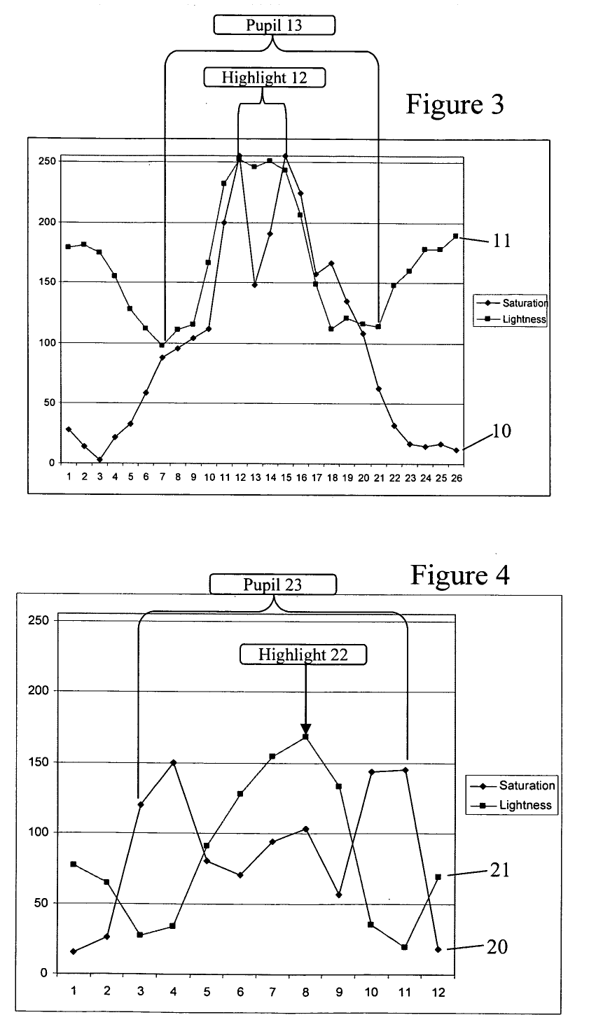

FIG. 3 is a graph showing the saturation and lightness behaviour of a typical type 1 highlight;

FIG. 4 is a graph showing the saturation and lightness behaviour of a typical type 2 highlight;

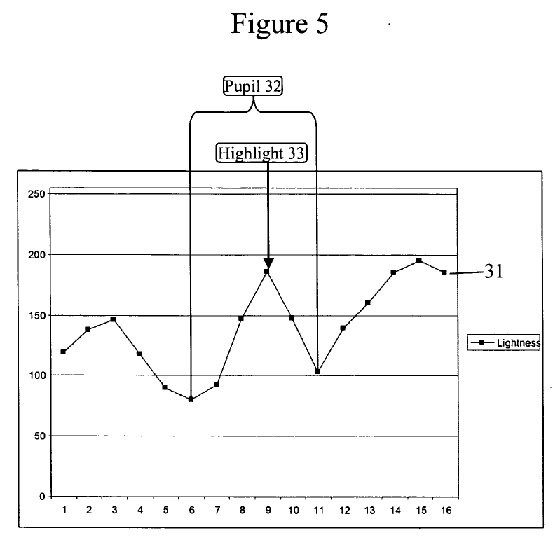

FIG. 5 is a graph showing the lightness behaviour of a typical type 3 highlight;

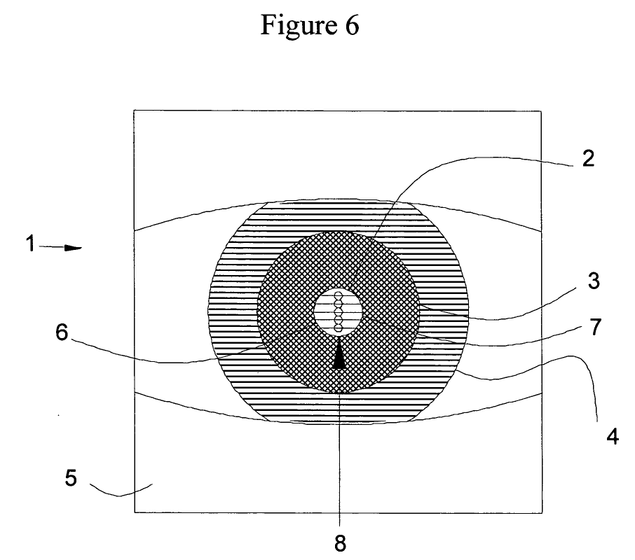

FIG. 6 is a schematic diagram of the red-eye feature of FIG. 2, showing pixels identified in the detection of a highlight;

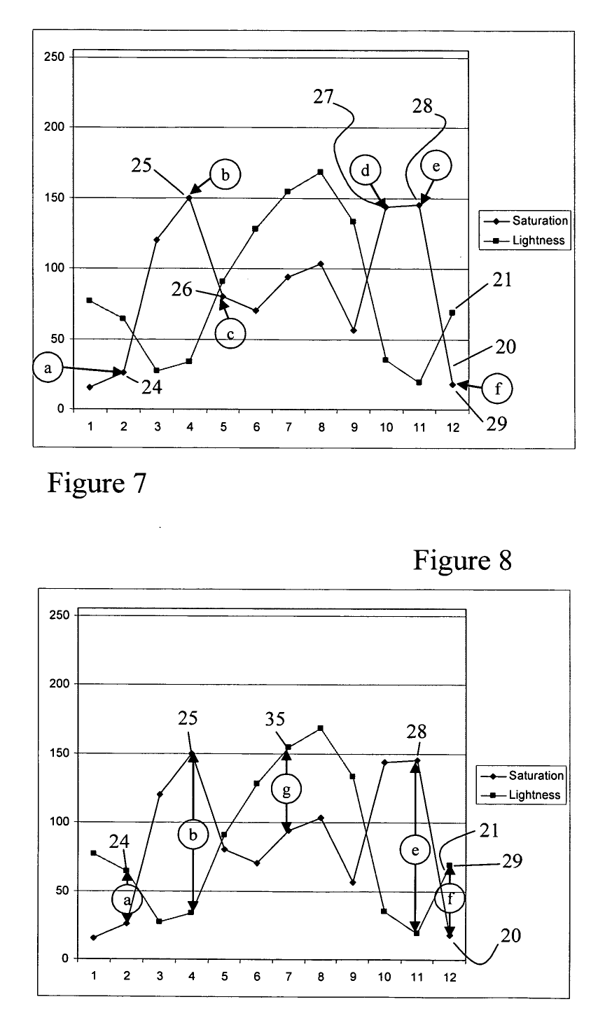

FIG. 7 is a graph showing points of the type 2 highlight of FIG. 4 identified by the detection algorithm;

FIG. 8 is a graph showing the comparison between saturation and lightness involved in the detection of the type 2 highlight of FIG. 4;

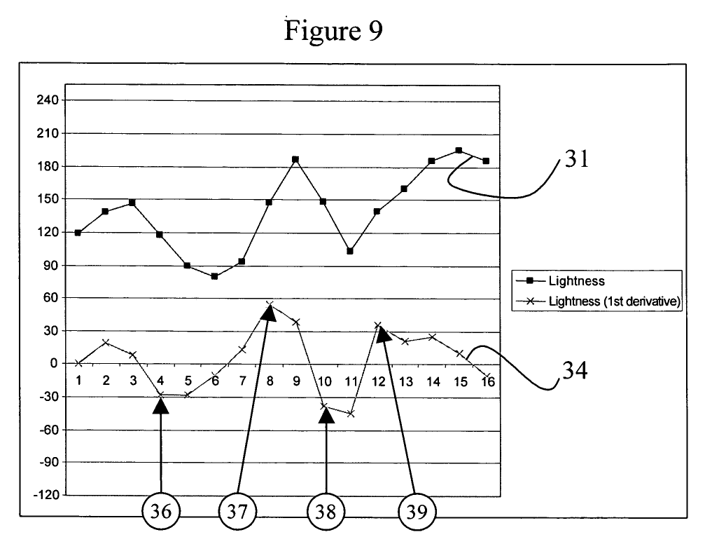

FIG. 9 is a graph showing the lightness and first derivative behaviour of the type 3 highlight of FIG. 5;

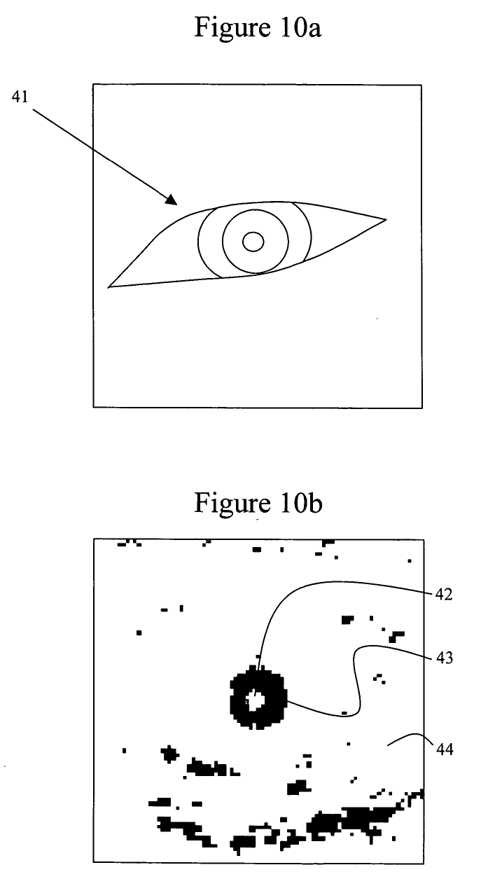

FIGS. 10a and FIG. 10b illustrates the technique for red area detection;

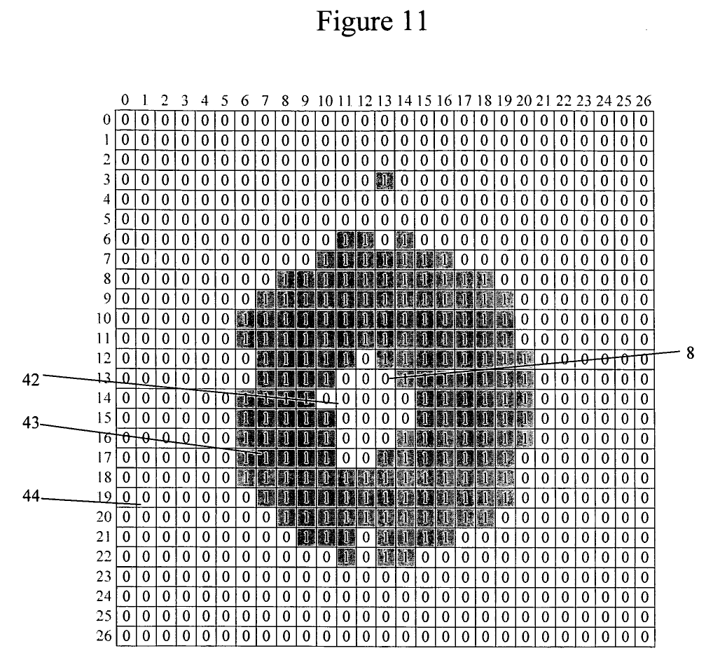

FIG. 11 shows an array of pixels indicating the correctability of pixels in the array;

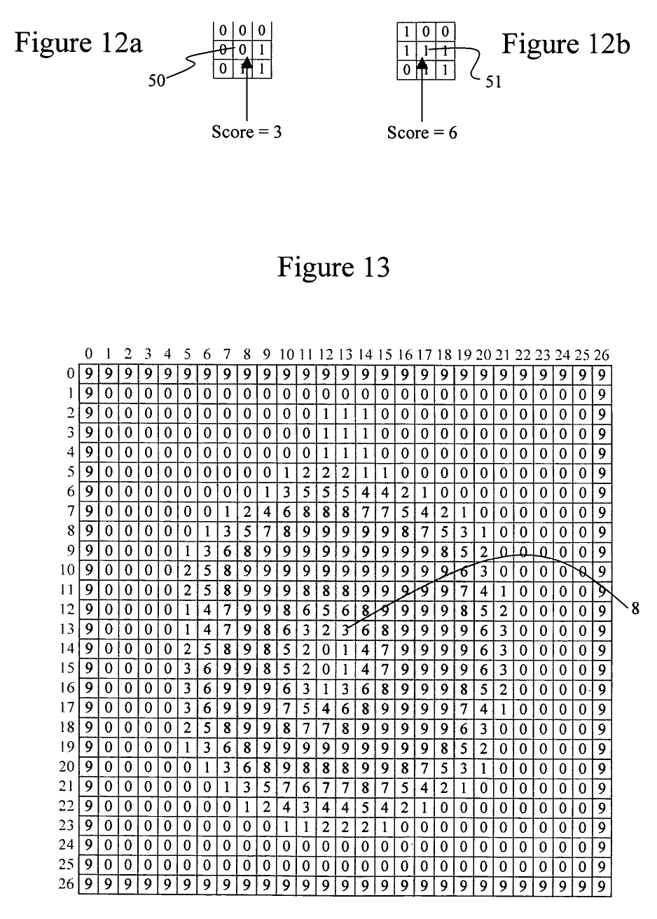

FIGS. 12a and 12b shows a mechanism for scoring pixels in the array of FIG. 11;

FIG. 13 shows an array of scored pixels generated from the array of FIG. 11;

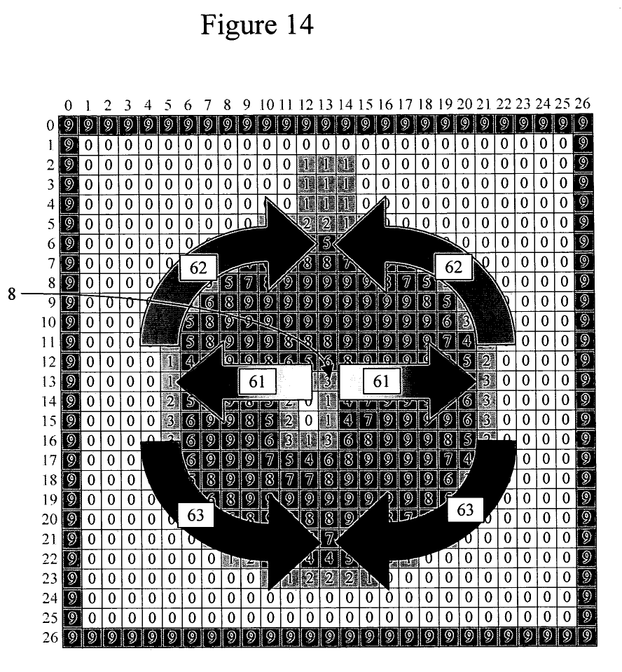

FIG. 14 is a schematic diagram illustrating generally the method used to identify the edges of the correctable area of the array of FIG. 13;

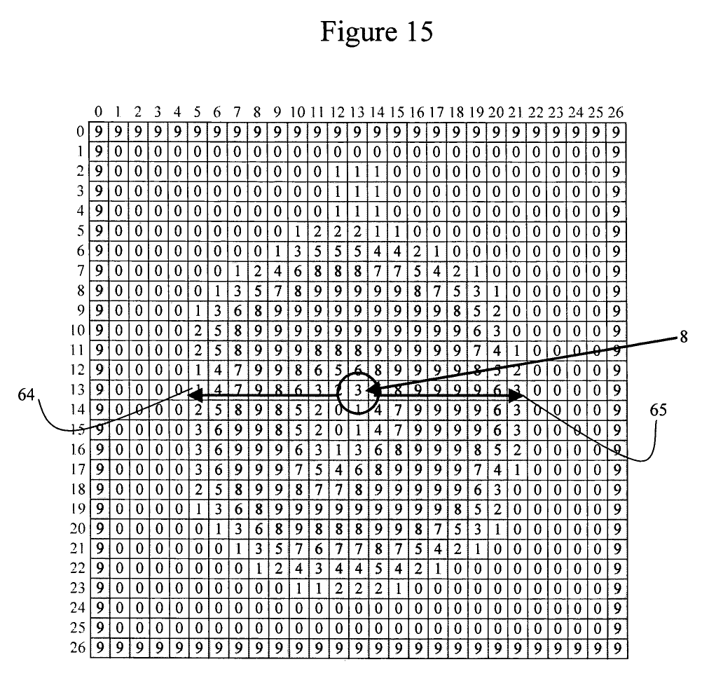

FIG. 15 shows the array of FIG. 13 with the method used to find the edges of the area in one row of pixels;

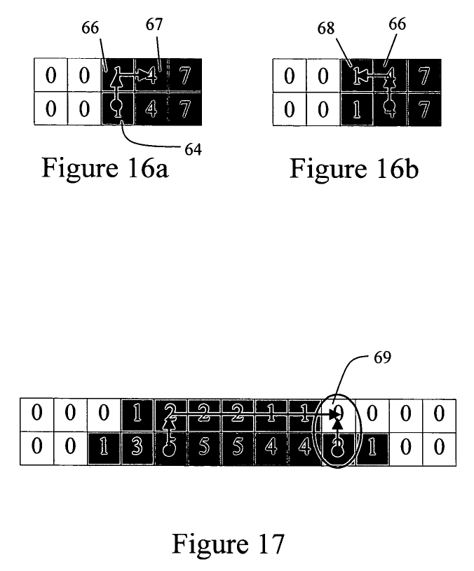

FIGS. 16a and 16b show the method used to follow the edge of correctable pixels upwards;

FIG. 17 shows the method used to find the top edge of a correctable area;

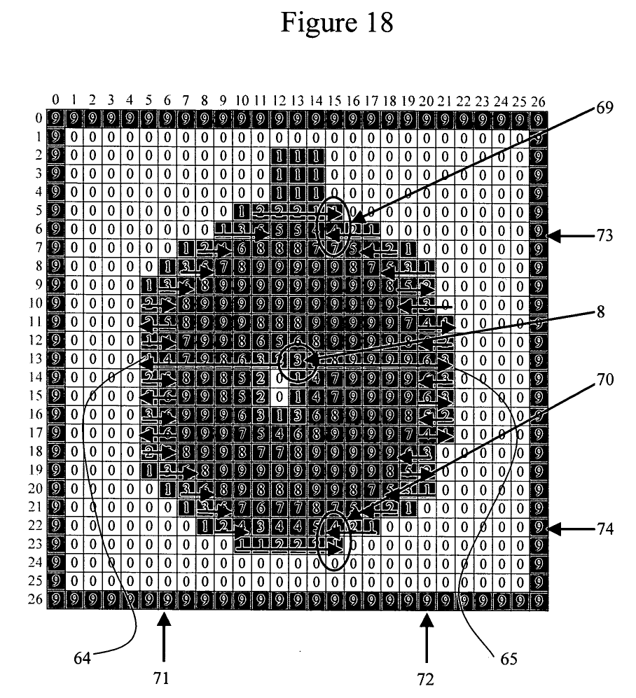

FIG. 18 shows the array of FIG. 13 and illustrates in detail the method used to follow the edge of the correctable area;

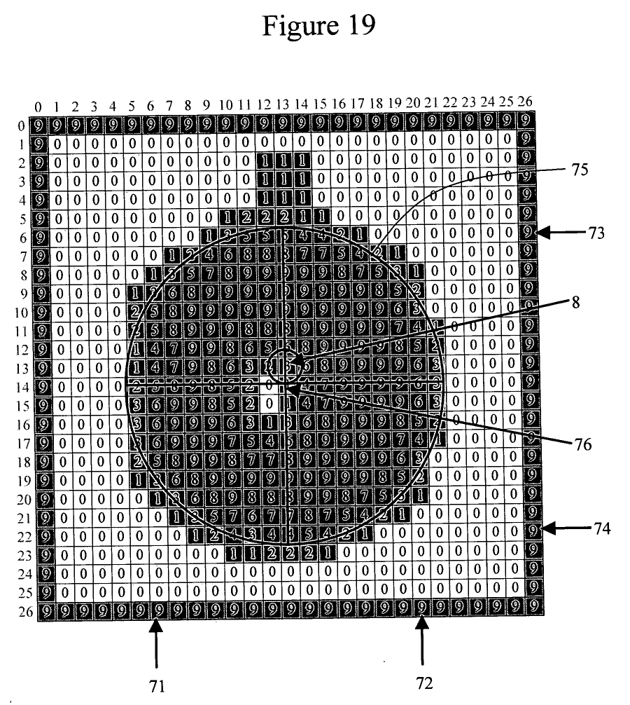

FIG. 19 shows the radius of the correctable area of the array of FIG. 13;

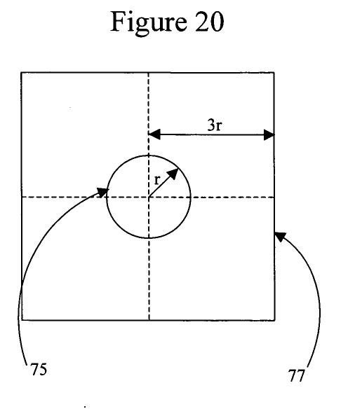

FIG. 20 is a schematic diagram showing the extent of the area examined for skin tones; and

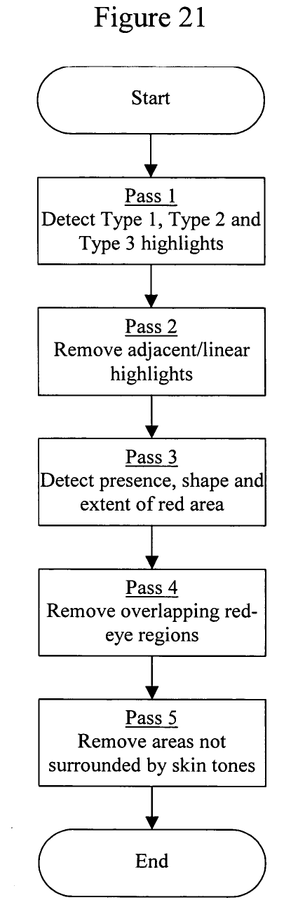

FIG. 21 is a flow chart showing the stages of detection of red-eye features.

When processing a digital image which may or may not contain red-eye features, in order to correct for such features as efficiently as possible, it is useful to apply a filter to determine whether such features could be present, find the features, and apply a red-eye correction to those features, preferably without the intervention of the user.

In its very simplest form, an automatic red-eye filter can operate in a very straightforward way. Since red-eye features can only occur in photographs in which a flash was used, no red-eye reduction need be applied if no flash was fired. However, if a flash was used, or if there is any doubt as to whether a flash was used, then the image should be searched for features resembling red-eye. If any red-eye features are found, they are corrected. This process is shown in FIG. 1.

An algorithm putting into practice the process of FIG. 1 begins with a quick test to determine whether the image could contain red-eye: was the flash fired? If this question can be answered ‘No’ with 100% certainty, the algorithm can terminate; if the flash was not fired, the image cannot contain red-eye. Simply knowing that the flash did not fire allows a large proportion of images to be filtered with very little processing effort.

For any image where it cannot be determined for certain that the flash was not fired, a more detailed examination must be performed using the red-eye detection module described below.

If no red-eye features are detected, the algorithm can end without needing to modify the image. However, if red-eye features are found, each must be corrected using the red-eye correction module described below.

Once the red-eye correction module has processed each red-eye feature, the algorithm ends.

The output from the algorithm is an image where all detected occurrences of red-eye have been corrected. If the image contains no red-eye, the output is an image which looks substantially the same as the input image. It may be that the algorithm detected and ‘corrected’ features on the image which resemble red-eye closely, but it is likely that the user will not notice these erroneous ‘corrections’.

The algorithm for detecting red-eye features locates a point within each red-eye feature and the extent of the red area around it.

FIG. 2 is a schematic diagram showing a typical red-eye feature 1. At the centre of the feature 1 is a white or nearly white “highlight” 2, which is surrounded by a region 3 corresponding to the subject's pupil. In the absence of red-eye, this region 3 would normally be black, but in a red-eye feature this region 3 takes on a reddish hue. This can range from a dull glow to a bright red. Surrounding the pupil region 3 is the iris 4, some or all of which may appear to take on some of the red glow from the pupil region 3.

The appearance of the red-eye feature depends on a number of factors, including the distance of the camera from the subject. This can lead to a certain amount of variation in the form of red-eye feature, and in particular the behaviour of the highlight. In practice, red-eye features and their highlights fall into one of three categories:

The first category is designated as “Type 1”. This occurs when the eye exhibiting the red-eye feature is large, as typically found in portraits and close-up pictures. The highlight 2 is at least one pixel wide and is clearly a separate feature to the red pupil 3. The behaviour of saturation and lightness for an exemplary Type 1 highlight is shown in FIG. 3.

Type 2 highlights occur when the eye exhibiting the red-eye feature is small or distant from the camera, as is typically found in group photographs. The highlight 2 is smaller than a pixel, so the red of the pupil mixes with the small area of whiteness in the highlight, turning an area of the pupil pink, which is an unsaturated red. The behaviour of saturation and lightness for an exemplary Type 2 highlight is shown in FIG. 4.

Type 3 highlights occur under similar conditions to Type 2 highlights, but they are not as saturated. They are typically found in group photographs where the subject is distant from the camera. The behaviour of lightness for an exemplary Type 3 highlight is shown in FIG. 5.

The red-eye detection algorithm begins by searching for regions in the image which could correspond to highlights 2 of red-eye features. The image is first transformed so that the pixels are represented by hue, saturation and lightness values. The algorithm then searches for regions which could correspond to Type 1, Type 2 and Type 3 highlights. The search for all highlights, of whatever type, could be made in a single pass, although it is computationally simpler to make a search for Type 1 highlights, then a separate search for Type 2 highlights, and then a final search for Type 3 highlights.

Most of the pixels in a Type 1 highlight of a red-eye feature have a very high saturation, and it is unusual to find areas this saturated elsewhere on facial pictures. Similarly, most Type 1 highlights will have high lightness values. FIG. 3 shows the saturation 10 and lightness 11 profile of one row of pixels in an exemplary Type 1 highlight. The region in the centre of the profile with high saturation and lightness corresponds to the highlight region 12. The pupil 13 in this example includes a region outside the highlight region 12 in which the pixels have lightness values lower than those of the pixels in the highlight. It is also important to note that not only will the saturation and lightness values of the highlight region 12 be high, but also that they will be significantly higher than those of the regions immediately surrounding them. The change in saturation from the pupil region 13 to the highlight region 12 is very abrupt.

The Type 1 highlight detection algorithm scans each row of pixels in the image, looking for small areas of light, highly saturated pixels. During the scan, each pixel is compared with its preceding neighbour (the pixel to its left). The algorithm searches for an abrupt increase in saturation and lightness, marking the start of a highlight, as it scans from the beginning of the row. This is known as a “rising edge”. Once a rising edge has been identified, that pixel and the following pixels (assuming they have a similarly high saturation and lightness) are recorded, until an abrupt drop in saturation is reached, marking the other edge of the highlight. This is known as a “falling edge”. After a falling edge, the algorithm returns to searching for a rising edge marking the start of the next highlight.

A typical algorithm might be arranged so that a rising edge is detected if:

1. The pixel is highly saturated (saturation>128).

2. The pixel is significantly more saturated than the previous one (this pixel's saturation—previous pixel's saturation>64).

3. The pixel has a high lightness value (lightness>128)

4. The pixel has a “red” hue (210≦hue≦255 or 0≦hue≦10).

The rising edge is located on the pixel being examined. A falling edge is detected if:

the pixel is significantly less saturated than the previous one (previous pixel's saturation—this pixel's saturation>64).

The falling edge is located on the pixel preceding the one being examined.

An additional check is performed while searching for the falling edge. After a defined number of pixels (for example 10) have been examined without finding a falling edge, the algorithm gives up looking for the falling edge. The assumption is that there is a maximum size that a highlight in a red-eye feature can be—obviously this will vary depending on the size of the picture and the nature of its contents (for example, highlights will be smaller in group photos than individual portraits at the same resolution). The algorithm may determine the maximum highlight width dynamically, based on the size of the picture and the proportion of that size which is likely to be taken up by a highlight (typically between 0.25% and 1% of the picture's largest dimension).

If a highlight is successfully detected, the co-ordinates of the rising edge, falling edge and the central pixel are recorded.

The algorithm is as follows:

for each row in the bitmap

looking for rising edge = true
loop from 2^{nd} pixel to last pixel

if looking for rising edge

if saturation of this pixel > 128 and...
...this pixel's saturation − previous pixel's
saturation > 64 and...
...lightness of this pixel > 128 and...
...hue of this pixel ≧ 210 or ≦ 10 then

rising edge = this pixel
looking for rising edge = false

end if

else

if previous pixel's saturation-this pixel's
saturation > 64 then

record position of rising edge
record position of falling edge (previous pixel)
record position of centre pixel
looking for rising edge = true

end if

end if
if looking for rising edge = false and...
...rising edge was detected more than 10 pixels ago

looking for rising edge = true

end if

end loop

end for

The result of this algorithm on the red-eye feature 1 is shown in FIG. 6. For this feature, since there is a single highlight 2, the algorithm will record one rising edge 6, one falling edge 7 and one centre pixel 8 for each row the highlight covers. The highlight 2 covers five rows, so five central pixels 8 are recorded. In FIG. 6, horizontal lines stretch from the pixel at the rising edge to the pixel at the falling edge. Circles show the location of the central pixels 8.

Following the detection of Type 1 highlights and the identification of the central pixel in each row of the highlight, the detection algorithm moves on to Type 2 highlights.

Type 2 highlights cannot be detected without using features of the pupil to help. FIG. 4 shows the saturation 20 and lightness 21 profile of one row of pixels of an exemplary Type 2 highlight. The highlight has a very distinctive pattern in the saturation and lightness channels, which gives the graph an appearance similar to interleaved sine and cosine waves.

The extent of the pupil 23 is readily discerned from the saturation curve, the red pupil being more saturated than its surroundings. The effect of the white highlight 22 on the saturation is also evident: the highlight is visible as a peak 22 in the lightness curve, with a corresponding drop in saturation. This is because the highlight is not white, but pink, and pink does not have high saturation. The pinkness occurs because the highlight 22 is smaller than one pixel, so the small amount of white is mixed with the surrounding red to give pink.

Another detail worth noting is the rise in lightness that occurs at the extremities of the pupil 23. This is due more to the darkness of the pupil than the lightness of its surroundings. It is, however, a distinctive characteristic of this type of red-eye feature.

The detection of a Type 2 highlight is performed in two phases. First, the pupil is identified using the saturation channel. Then the lightness channel is checked for confirmation that it could be part of a red-eye feature. Each row of pixels is scanned as for a Type 1 highlight, with a search being made for a set of pixels satisfying certain saturation conditions. FIG. 7 shows the saturation 20 and lightness 21 profile of the red-eye feature illustrated in FIG. 4, together with detectable pixels ‘a’ 24, ‘b’ 25, ‘c’ 26, ‘d’ 27, ‘e’ 28, ‘f’ 29 on the saturation curve 20.

The first feature to be identified is the fall in saturation between pixel ‘b’ 25 and pixel ‘c’ 26. The algorithm searches for an adjacent pair of pixels in which one pixel 25 has saturation≧100 and the following pixel 26 has a lower saturation than the first pixel 25. This is not very computationally demanding because it involves two adjacent points and a simple comparison. Pixel ‘c’ is defined as the pixel 26 further to the right with the lower saturation. Having established the location 26 of pixel ‘c’, the position of pixel ‘b’ is known implicitly—it is the pixel 25 preceding ‘c’.

Pixel ‘b’ is the more important of the two—it is the first peak in the saturation curve, where a corresponding trough in lightness should be found if the highlight is part of a red-eye feature.

The algorithm then traverses left from ‘b’ 25 to ensure that the saturation value falls continuously until a pixel 24 having a saturation value of≦50 is encountered. If this is the case, the first pixel 24 having such a saturation is designated ‘a’. Pixel ‘f’ is then found by traversing rightwards from ‘c’ 26 until a pixel 29 with a lower saturation than ‘a’ 24 is found. The extent of the red-eye feature is now known.

The algorithm then traverses leftwards along the row from ‘f’ 29 until a pixel 28 is found with higher saturation than its left-hand neighbour 27. The left hand neighbour 27 is designated pixel ‘d’ and the higher saturation pixel 28 is designated pixel ‘e’. Pixel ‘d’ is similar to ‘c’; its only purpose is to locate a peak in saturation, pixel ‘e’.

A final check is made to ensure that the pixels between ‘b’ and ‘e’ all have lower saturation than the highest peak.

It will be appreciated that if any of the conditions above are not fulfilled then the algorithm will determine that it has not found a Type 2 highlight and return to scanning the row for the next pair of pixels which could correspond to pixels ‘b’ and ‘c’ of a Type 2 highlight. The conditions above can be summarised as follows:

| Range | Condition |
|---|---|
| bc | Saturation(c) < Saturation(b) and Saturation(b) ≧ 100 |
| ab | Saturation has been continuously rising from a to b and |
| | Saturation(a) ≦ 50 |
| af | Saturation(f) ≦ Saturation(a) |
| ed | Saturation(d) < Saturation(e) |
| be | All Saturation(b..e) < max(Saturation(b), Saturation(e)) |

If all the conditions are met, a feature similar to the saturation curve in FIG. 7 has been detected. The detection algorithm then compares the saturation with the lightness of pixels ‘a’ 24, ‘b’ 25, ‘e’ 28 and ‘f’ 29, as shown in FIG. 8, together with the centre pixel 35 of the feature defined as pixel ‘g’ half way between ‘a’ 24 and ‘f’ 29. The hue of pixel ‘g’ is also a consideration. If the feature corresponds to a Type 2 highlight, the following conditions must be satisfied:

| Pixel | Description | Condition |
|---|---|---|
| ‘a’ 24 | Feature start | Lightness > Saturation |
| ‘b’ 25 | First peak | Saturation > Lightness |
| ‘g’ 35 | Centre | Lightness > Saturation and Lightness ≧ 100, and: |
| | | 220 ≦ Hue ≦ 255 or 0 ≦ Hue ≦ 10 |
| ‘e’ 27 | Second peak | Saturation > Lightness |
| ‘f’ 28 | Feature end | Lightness > Saturation |

It will be noted that the hue channel is used for the first time here. The hue of the pixel 35 at the centre of the feature must be somewhere in the red area of the spectrum. This pixel will also have a relatively high lightness and mid to low saturation, making it pink—the colour of highlight that the algorithm sets out to identify.

Once it is established that the row of pixels matches the profile of a Type 2 highlight, the centre pixel 35 is identified as the centre point 8 of the highlight for that row of pixels as shown in FIG. 6, in a similar manner to the identification of centre points for Type 1 highlights described above.

The detection algorithm then moves on to Type 3 highlights. FIG. 5 shows the lightness profile 31 of a row of pixels for an exemplary Type 3 highlight 32 located roughly in the centre of the pupil 33. The highlight will not always be central: the highlight could be offset in either direction, but the size of the offset will typically be quite small (perhaps ten pixels at the most), because the feature itself is never very large.

Type 3 highlights are based around a very general characteristic of red-eyes, visible also in the Type 1 and Type 2 highlights shown in FIGS. 3 and 4. This is the ‘W’ shaped curve in the lightness channel 31, where the central peak is the highlight 12, 22, 32, and the two troughs correspond roughly to the extremities of the pupil 13, 23, 33. This type of feature is simple to detect, but it occurs with high frequency in many images, and most occurrences are not caused by red-eye.

The method for detecting Type 3 highlights is simpler and quicker than that used to find Type 2 highlights. The highlight is identified by detecting the characteristic ‘W’ shape in the lightness curve 31. This is performed by examining the discrete analogue 34 of the first derivative of the lightness, as shown in FIG. 9. Each point on this curve is determined by subtracting the lightness of the pixel immediately to the left of the current pixel from that of the current pixel.

The algorithm searches along the row examining the first derivative (difference) points. Rather than analyse each point individually, the algorithm requires that pixels are found in the following order satisfying the following four conditions:

| Pixel | Condition |
|---|---|
| First 36 | Difference ≦ −20 |
| Second 37 | Difference ≧ 30 |
| Third 38 | Difference ≦ −30 |
| Fourth 39 | Difference ≧ 20 |

There is no constraint that pixels satisfying these conditions must be adjacent. In other words, the algorithm searches for a pixel 36 with a difference value of −20 or lower, followed eventually by a pixel 37 with a difference value of at least 30, followed by a pixel 38 with a difference value of −30 or lower, followed by a pixel 39 with value of at least 20. There is a maximum permissible length for the pattern—in one example it must be no longer than 40 pixels, although this is a function of the image size and any other pertinent factors.

An additional condition is that there must be two ‘large’ changes (at least one positive and at least one negative) in the saturation channel between the first 36 and last 39 pixels. A ‘large’ change may be defined as≧30.

Finally, the central point (the one half-way between the first 36 and last 39 pixels in FIG. 9) must have a “red” hue in the range 220≦Hue≦255 or 0≦Hue≦10.

The central pixel 8 as shown in FIG. 6 is defined as the central point midway between the first 36 and last 39 pixels.

The location of all of the central pixels 8 for all of the Type 1, Type 2 and Type 3 highlights detected are recorded into a list of highlights which may potentially be caused by red-eye. The number of central pixels 8 in each highlight is then reduced to one. As shown in FIG. 6, there is a central pixel 8 for each row covered by the highlight 2. This effectively means that the highlight has been detected five times, and will therefore need more processing than is really necessary. It will also be appreciated that it is also possible for the same highlight to be detected independently as a Type 1, Type 2 or Type 3 highlight, so it is possible that the same highlight could be detected up to three times on each row. It is therefore desirable to reduce the number of points in the list so that there is only one central point 8 recorded for each highlight region 2.

Furthermore, not all of the highlights identified by the algorithms above will necessarily be formed by red-eye features. Others could be formed, for example, by light reflected from corners or edges of objects. The next stage of the process therefore attempts to eliminate such highlights from the list, so that red-eye reduction is not performed on features which are not actually red-eye features.

There are a number of criteria which can be applied to recognise red-eye features as opposed to false features. One is to check for long strings of central pixels in narrow highlights—i.e. highlights which are essentially linear in shape. These may be formed by light reflecting off edges, for example, but will never be formed by red-eye.

This check for long strings of pixels may be combined with the reduction of central pixels to one. An algorithm which performs both these operations simultaneously may search through highlights identifying “strings” or “chains” of central pixels. If the aspect ratio, which is defined as the length of the string of central pixels 8 (see FIG. 6) divided by the largest width between the rising edge 6 and falling edge 7 of the highlight, is greater than a predetermined number, and the string is above a predetermined length, then all of the central pixels 8 are removed from the list of highlights. Otherwise only the central pixel of the string is retained in the list of highlights.

In other words, the algorithm performs two tasks:

removes roughly vertical chains of highlights from the list of highlights, where the aspect ratio of the chain is greater than a predefined value, and

removes all but the vertically central highlight from roughly vertical chains of highlights where the aspect ratio of the chain is less than or equal to a pre-defined value.

An algorithm which performs this combination of tasks is given below:

for each highlight

(the first section deals with determining the extent of the chain of
highlights - if any - starting at this one)
make ‘current highlight’ and ‘upper highlight’ = this highlight
make ‘widest radius’ = the radius of this highlight
loop

search the other highlights for one where: y co-ordinate =
current highlight's y co-ordinate + 1; and x co-ordinate =
current highlight's x co-ordinate (with a tolerance of ±1)
if an appropriate match is found

make ‘current highlight’ = the match
if the radius of the match > ‘widest radius’

make ‘widest radius’ = the radius of the match

end if

end if

until no match is found
(at this point, ‘current highlight’ is the lower highlight in the chain
beginning at ‘upper highlight’, so in this section, if the chain is
linear, it will be removed; if it is roughly circular, all but the
central highlight will be removed)
make ‘chain height’ = current highlight's y co-ordinate − top
highlight's y co-ordinate
make ‘chain aspect ratio’ = ‘chain height’ / ‘widest radius’
if ‘chain height’ >= ‘minimum chain height’ and ‘chain aspect
ratio’ > ‘minimum chain aspect ratio’

remove all highlights in the chain from the list of highlights

else

if ‘chain height’ > 1

remove all but the vertically central highlight in the
chain from the list of highlights

end if

end if

end for

A suitable threshold for ‘minimum chain height’ is three and a suitable threshold for ‘minimum chain aspect ratio’ is also three, although it will be appreciated that these can be changed to suit the requirements of particular images.

Having detected the centres of possible red-eyes and attempted to reduce the number of points per eye to one, the next stage is to determine the presence and size of the red area surrounding the central point. It should be borne in mind that, at this stage, it is not certain that all “central” points will be within red areas, and that not all red areas will necessarily be caused by red-eye.

A very general definition of a red-eye feature is an isolated, roughly circular area of reddish pixels. In almost all cases, this contains a highlight (or other area of high lightness), which will have been detected as described above. The next stage of the process is to determine the presence and extent of the red area surrounding any given highlight, bearing in mind that the highlight is not necessarily at the centre of the red area, and may even be on its edge. Further considerations are that there may be no red area, or that there may be no detectable boundaries to the red area because it is part of a larger feature—either of these conditions meaning that the highlight will not be classified as being part of a red-eye feature.

FIG. 10 illustrates the basic technique for area detection, and highlights a further problem which should be taken into account. All pixels surrounding the highlight 2 are classified as correctable or non-correctable. FIG. 10a shows a picture of a red-eye feature 41, and FIG. 10b shows a map of the correctable 43 and non-correctable 44 pixels in that feature. A pixel is defined as “correctable” if the following conditions are met:

| Channel | Condition |
|---|---|
| Hue | 220 ≦ Hue ≦ 255, or 0 ≦ Hue ≦ 10 |
| Saturation | Saturation ≧ 80 |
| Lightness | Lightness < 200 |

FIG. 10b clearly shows a roughly circular area of correctable pixels 43 surrounding the highlight 42. There is a substantial ‘hole’ of non-correctable pixels inside the highlight area 42, so the algorithm that detects the area must be able to cope with this. There are four phases in the determination of the presence and extent of the correctable area:

1. Determine correctability of pixels surrounding the highlight

2. Allocate a notional score or weighting to all pixels

3. Find the edges of the correctable area to determine its size

4. Determine whether the area is roughly circular

In phase 1, a two-dimensional array is constructed, as shown in FIG. 11, each cell containing either a 1 or 0 to indicate the correctability of the corresponding pixel. The pixel 8 identified earlier as the centre of the highlight is at the centre of the array (column 13, row 13 in FIG. 11). The array must be large enough that the whole extent of the pupil can be contained within it. In the detection of Type 2 and Type 3 highlights, the width of the pupil is identified, and the extent of the array can therefore be determined by multiplying this width by a predetermined factor. If the extent of the pupil is not already known, the array must be above a predetermined size, for example relative to the complete image.

In phase 2, a second array is generated, the same size as the first, containing a score for each pixel in the correctable pixels array. As shown in FIG. 12, the score of a pixel 50, 51 is the number of correctable pixels in the 3×3 square centred on the one being scored. In FIG. 12a, the central pixel 50 has a score of 3. In FIG. 12b, the central pixel 51 has a score of 6.

Scoring is helpful for two reasons:

1. To bridge small gaps and holes in the correctable area, and thus prevent edges from being falsely detected.

2. To aid correction of the area, if it is eventually classified as a red-eye feature. This makes use of the fact that pixels near the boundaries of the correctable area will have low scores, while those well inside it will have high scores. During correction, pixels with high scores can be adjusted by a large amount, while those with lower scores are adjusted less. This allows the correction to be blended into the surroundings, giving corrected eyes a natural appearance, and helping to disguise any falsely corrected areas.

The result of calculating pixel scores for the array is shown in FIG. 13. Note that the pixels along the edge of the array are all assigned scores of 9, regardless of what the calculated score would be. The effect of this is to assume that everything beyond the extent of the array is correctable. Therefore if any part of the correctable area surrounding the highlight extends to the edge of the array, it will not be classified as an isolated, closed shape.

Phase 3 uses the pixel scores to find the boundary of the correctable area. The described example only attempts to find the leftmost and rightmost columns, and topmost and bottom-most rows of the area, but there is no reason why a more accurate tracing of the area's boundary could not be attempted.

It is necessary to define a threshold that separates pixels considered to be correctable from those that are not. In this example, any pixel with a score of≧24 is counted as correctable. This has been found to give the best balance between traversing small gaps whilst still recognising isolated areas.

The algorithm for phase 3 has three steps, as shown in FIG. 14:

1. Start at the centre of the array and work outwards 61 to find the edge of the area.

2. Simultaneously follow the left and right edges 62 of the upper section until they meet.

3. Do the same as step 2 for the lower section 63.

The first step of the process is shown in more detail in FIG. 15. The start point is the central pixel 8 in the array with co-ordinates (13, 13), and the objective is to move from the centre to the edge of the area 64, 65. To take account of the fact that the pixels at the centre of the area may not be classified as correctable (as is the case here), the algorithm does not attempt to look for an edge until it has encountered at least one correctable pixel. The process for moving from the centre 8 to the left edge 64 can be expressed is as follows:

current_pixel = centre_pixel
left edge = undefined
if current_pixel's score < threshold then

move current_pixel left until current_pixel's score ≧ threshold

end if
move current_pixel left until:

current_pixel's score < threshold, or
the beginning of the row is passed

if the beginning of the row was not passed then

left_edge = pixel to the right of current_pixel

end if

Similarly, the method for locating the right edge 65 can be expressed as:

current_pixel = centre_pixel
right_edge = undefined
if current_pixel's score < threshold then

move current_pixel right until current_pixel's score ≧ threshold

end if
move current_pixel right until:

current_pixel's score < threshold, or
the end of the row is passed

if the end of the row was not passed then

right_edge = pixel to the left of current_pixel

end if

At this point, the left 64 and right 65 extremities of the area on the centre line are known, and the pixels being pointed to have co-ordinates (5, 13) and (21, 13).

The next step is to follow the outer edges of the area above this row until they meet or until the edge of the array is reached. If the edge of the array is reached, we know that the area is not isolated, and the feature will therefore not be classified as a potential red-eye feature.

As shown in FIG. 16, the starting point for following the edge of the area is the pixel 64 on the previous row where the transition was found, so the first step is to move to the pixel 66 immediately above it (or below it, depending on the direction). The next action is then to move towards the centre of the area 67 if the pixel's value 66 is below the threshold, as shown in FIG. 16a, or towards the outside of the area 68 if the pixel 66 is above the threshold, as shown in FIG. 16b, until the threshold is crossed. The pixel reached is then the starting point for the next move.

The process of moving to the next row, followed by one or more moves inwards or outwards continues until there are no more rows to examine (in which case the area is not isolated), or until the search for the left-hand edge crosses the point where the search for the right-hand edge would start, as shown in FIG. 17.

The entire process is shown in FIG. 18, which also shows the left 64, right 65, top 69 and bottom 70 extremities of the area, as they would be identified by the algorithm. The top edge 69 and bottom edge 70 are closed because in each case the left edge has passed the right edge. The leftmost column 71 of correctable pixels is that with y-coordinate=6 and is one column to the right of the leftmost extremity 64. The rightmost column 72 of correctable pixels is that with y-coordinate=20 and is one column to the right of the rightmost extremity 65. The topmost row 73 of correctable pixels is that with x-coordinate=6 and is one row down from the point 69 at which the left edge passes the right edge. The bottom-most row 74 of correctable pixels is that with x-coordinate=22 and is one row up from the point 70 at which the left edge passes the right edge.

Having successfully discovered the extremities of the area in phase 3, phase 4 now checks that the area is essentially circular. This is done by using a circle 75 whose diameter is the greater of the two distances between the leftmost 71 and rightmost 72 columns, and topmost 73 and bottom-most 74 rows to determine which pixels in the correctable pixels array to examine, as shown in FIG. 19. The circle 75 is placed so that its centre 76 is midway between the leftmost 71 and rightmost 72 columns and the topmost 73 and bottom-most 74 rows. At least 50% of the pixels within the circular area 75 must be classified as correctable (i.e. have a value of I as shown in FIG. 11) for the area to be classified as circular 75.

It will be noted that, in this case, the centre 76 of the circle is not in the same position as the centre 8 of the highlight.

Following the identification of the presence and extent of each red area, a search can be made for duplicate and overlapping features. If the same or similar circular areas 75 are identified when starting from two distinct highlight starting points 8, then the highlights can be taken to be due to a single red-eye feature. This is necessary because the stage of removing linear features described above may still have left in place more than one highlight for any particular red-eye feature. One of the two duplicate features must be removed from the complete list of red-eye features.

In addition, it may be that two different features are found which “overlap” each other. This can occur when there are isolated areas close to each other. The circle 75 shown in FIG. 19 is used to determine whether areas overlap. In a situation in which two or more isolated areas, each having an associated circle, are close to each other, the circles may overlap. It has been found that such features are almost never caused by red-eye, and therefore both features should be eliminated.

There are also a few cases where the same area is identified twice—perhaps because two separate features in it are detected as highlights, giving two different starting points, as described above. Sometimes, different starting points combined with the shape of the area will confuse the area detection, causing it to give two different results for the same area. The result is again two isolated, overlapping features. In such cases it is safer to delete them both than attempt to correct either of them.

The algorithm to remove duplicate and overlapping regions works as follows. It is supplied with a list of regions, through which it iterates. For each region in the list, a decision is made as to whether that region should be copied to a second list. If a region is found which overlaps another one, neither of the two regions will be copied to the second list. If two identical regions are found (with the same centre and radius), only the first one will be copied. When all regions in the supplied list have been examined, the second list will contain only non-duplicate, non-overlapping regions.

The algorithm can be expressed in pseudocode as follows:

for each red-eye region

search forwards through the list for an intersecting, non-identical red-
eye region
if such a region could not be found

search backwards through the list for an intersecting or
identical red-eye region
if such a region could not be found

add the current region to the de-duplicated region list

end if

end if

end for

Two non-identical red-eye features are judged to overlap if the sum of their radii is greater than the distance between their centres.

Following the removal of duplicate and overlapping features, the list of red-eye features is further filtered by the removal of areas not surrounded by skin tones.

In most cases, red-eye features will be surrounded on most sides by skin-coloured areas. Dressing-up, face painting and so on are exceptions, but can generally be treated as unusual enough to risk discarding. ‘Skin-coloured’ may seem like a rather broad term as there are a lot of different skin tones that can be changed in various ways by different lighting conditions. However, if unusual lighting conditions are ignored the range of hues of skin-coloured areas is quite limited, and while illumination can vary a lot, saturation is generally not high. Furthermore, since a single pigment is responsible for coloration of skin in all humans, the density of the pigmentation does not markedly affect the hue.

People from differing regions, races and environments may possess skin tones with visibly disparate coloration, and medical conditions, exposure to sunlight and genetic variation may also affect the apparent colour. However, the naturally occurring hues in all human skin fall within a specific, narrow range. On a scale of 0-255, hue of skin is generally between 220 and 255 or 0 and 30 (both inclusive). The saturation is 160 or less on the same scale. In other words, hues are in the red part of the spectrum and saturation is not high.

It is reasonable to disregard the effects of coloured lighting given the assumption that, since red-eye is caused by a flashlight, subjects' faces are likely to be illuminated with a sufficient amount of white light for their skin tones to fall into the range described above.

In the final stage of red-eye detection, any areas that are not surrounded by a sufficient number of skin-coloured pixels are discarded. The check for skin-coloured pixels occurs late in the process because it involves the inspection of a comparatively large number of pixels, so it is therefore best performed as few times as possible to ensure good performance.

As shown in FIG. 20, for each potential red-eye feature, a square area 77 centred on the red-eye area 75 is examined. The square area 77 has a side of length three times the diameter of the red-eye circle 75. All pixels within the square area 77 are examined and will contribute to the final result, including those inside the red-eye circle 75. For a feature to be classified as a red-eye feature, the following conditions must be met:

| Channel | Condition | Proportion |
|---|---|---|
| Hue | 220 ≦ Hue ≦ 255, or 0 ≦ Hue ≦ 30 | 70% |
| Saturation | Saturation ≦ 160 | 70% |

The third column shows what proportion of the total number of pixels within the area must fulfill the condition.

The various stages of red-eye detection are shown as a flow chart in FIG. 21. Pass 1 involves the detection of the central pixels 8 of pixel within rows Type 1, Type 2 and Type 3 highlights, as shown in FIGS. 2 to 9. The location of these central pixels 8 are stored in a list of potential highlight locations. Pass 2 involves the removal from the list of adjacent and linear highlights. Pass 3 involves the determination of the presence and extent of the red area around each central pixel 8, as shown in FIGS. 10 to 19. Pass 4 involves the removal of overlapping red-eye features from the list. Pass 5 involves the removal of features not surrounded by skin tones, as shown in FIG. 20.

Once detection is complete, red-eye correction is carried out on the features left in the list.

Red-eye correction is based on the scores given to each pixel during the identification of the presence and extent of the red area, as shown in FIG. 13. Only pixels within the circle 75 identified at the end of this process are corrected, and the magnitude of the correction for each pixel is determined by that pixel's score. Pixels near the edge of the area 75 have lower scores, enabling the correction to be blended in to the surrounding area. This minimises the chances of a visible transition between corrected and non-corrected pixels. This would look unnatural and draw attention to the corrected area.

The pixels within the circle 75 are corrected as follows:

| Channel | Correction |
|---|---|
| Lightness | Lightness = Lightness × (1 − (0.06 × (1 + Score))) |
| Saturation | if Saturation > 100 then Saturation = 64, else no change |

The new lightness of the pixel is directly and linearly related to its score assigned in the determination of presence and extent of the red area as shown in FIG. 13. In general, the higher the pixel's score, the closer to the centre of the area it must be, and the darker it will be made. No pixels are made completely black because it has been found that correction looks more natural with very dark (as opposed to black) pixels. Pixels with lower scores have less of their lightness taken away. These are the ones that will border the highlight, the iris or the eyelid. The former two are usually lighter than the eventual colour of the corrected pupil.

For the saturation channel, the aim is not to completely de-saturate the pixel (thus effectively removing all hints of red from it), but to substantially reduce it. The accompanying decrease in lightness partly takes care of making the red hue less apparent—darker red will stand out less than a bright, vibrant red. However, modifying the lightness on its own may not be enough, so all pixels with a saturation of more than 100 have their saturation reduced to 64. These numbers have been found to give the best results, but it will be appreciated that the exact numbers may be changed to suit individual requirements. This means that the maximum saturation within the corrected area is 100, but any pixels that were particularly highly saturated end up with a saturation considerably below the maximum. This results in a very subtle mottled appearance to the pupil, where all pixels are close to black but there is a detectable hint of colour. It has been found that this is a close match for how non-red-eyes look.

It will be noted that the hue channel is not modified during correction: no attempt is made to move the pixel's hue to another area of the spectrum—the redness is reduced by darkening the pixel and reducing its saturation.

It will be appreciated that the detection module and correction module can be implemented separately. For example, the detection module could be placed in a digital camera or similar, and detect red-eye features and provide a list of the location of these features when a photograph is taken. The correction module could then be applied after the picture is downloaded from the camera to a computer.

The method according to the invention provides a number of advantages. It works on a whole image, although it will be appreciated that a user could select part of an image to which red-eye reduction is to be applied, for example just a region containing faces. This would cut down on the processing required. If a whole image is processed, no user input is required. Furthermore, the method does not need to be perfectly accurate. If red-eye reduction is performed on a feature not caused by red-eye, it is unlikely that a user would notice the difference.

Since the red-eye detection algorithm searches for light, highly saturated points before searching for areas of red, the method works particularly well with JPEG-compressed images and other formats where colour is encoded at a low resolution.

The detection of different types of highlight improves the chances of all red-eye features being detected.

It will be appreciated that variations from the above described embodiments may still fall within the scope of the invention. For example, the method has been described with reference to people's eyes, for which the reflection from the retina leads to a red region. For some animals, “red-eye” can lead to green or yellow reflections. The method according to the invention may be used to correct for this effect. Indeed, the initial search for highlights rather than a region of a particular hue makes the method of the invention particularly suitable for detecting non-red animal “red-eye”.

Furthermore, the method has generally been described for red-eye features in which the highlight region is located in the centre of the red pupil region. However the method will still work for red-eye features whose highlight region is off-centre, or even at the edge of the red region.

1. A method of detecting red-eye features in a digital image, comprising:
identifying pupil regions in the image, a pupil region comprising:
a first saturation peak adjacent a first edge of the pupil region comprising one or more pixels having a higher saturation than pixels immediately outside the pupil region;
a second saturation peak adjacent a second edge of the pupil region comprising one or more pixels having a higher saturation than pixels immediately outside the pupil region; and
a saturation trough between the first and second saturation peaks, the saturation trough comprising one or more pixels having a lower saturation than the pixels in the first and second saturation peaks; and
determining whether each pupil region corresponds to part of a red-eye feature on the basis of further selection criteria.

2. A method as claimed in claim 1, wherein the step of identifying a pupil region includes confirming that all of the pixels between a first peak pixel having the highest saturation in the first saturation peak and a second peak pixel having the highest saturation in the second saturation peak have a lower saturation than the higher of the saturations of the first and second peak pixels.

3. A method as claimed in claim 1, wherein the step of identifying a pupil region includes confirming that a pixel immediately outside the pupil region has a saturation value below a predetermined value.

4. A method as claimed in claim 1, wherein the step of identifying a pupil region includes:
confirming that a pixel in the first saturation peak has a saturation value higher than its lightness value; and
confirming that a pixel in the second saturation peak has a saturation value higher than its lightness value.

5. A method as claimed in claim 1, wherein the step of identifying a pupil region includes:
confirming that a pixel immediately outside the pupil region has a saturation value lower than its lightness value.

6. A method as claimed in claim 1, wherein the step of identifying a pupil region includes:
confirming that a pixel in the saturation trough has a saturation value lower than its lightness value.

7. A method as claimed in claim 1, wherein the step of identifying a pupil region includes:
confirming that a pixel in the saturation trough has a lightness value greater than or equal to about 100.

8. A method as claimed in claim 1, wherein the step of identifying a pupil region includes:
confirming that a pixel in the saturation trough has a hue greater than or equal to about 220 or less than or equal to about 10.

9. A method of detecting red-eye features in a digital image, comprising:
identifying pupil regions in the image by searching for a row of pixels with a predetermined saturation profile, and confirming that selected pixels within that row have lightness values satisfying predetermined conditions; and
determining whether each pupil region corresponds to part of a red-eye feature on the basis of further selection criteria.

10. A method of detecting red-eye features in a digital image, comprising:
identifying pupil regions in the image, a pupil region including a row of pixels comprising:
a first pixel having a lightness value lower than that of the pixel immediately to its left;
a second pixel having a lightness value higher than that of the pixel immediately to its left;
a third pixel having a lightness value lower than that of the pixel immediately to its left; and
a fourth pixel having a lightness value higher than that of the pixel immediately to its left;
wherein the first, second, third and fourth pixels are identified in that order when searching along the row of pixels from the left; and
determining whether each pupil region corresponds to part of a red-eye feature on the basis of further selection criteria.

11. A method as claimed in claim 10, wherein the first pixel has a lightness value at least about 20 lower than that of the pixel immediately to its left, the second pixel has a lightness value at least about 30 higher than that of the pixel immediately to its left, the third pixel has a lightness value at least about 30 lower than that of the pixel immediately to its left, and the fourth pixel has a lightness value at least about 20 higher than that of the pixel immediately to its left.

12. A method as claimed in claim 10, wherein the row of pixels in the pupil region includes at least two pixels each having a saturation value differing by at least about 30 from that of the pixel immediately to its left, one of the at least two pixels having a higher saturation value than its left hand neighbour and another of the at least two pixels having a saturation value lower than its left hand neighbour.

13. A method as claimed in claim 10, wherein the pixel midway between the first pixel and the fourth pixel has a hue greater than about 220 or less than about 10.

14. A method of detecting red-eye features in a digital image, comprising:
identifying highlight regions of the image having pixels with a substantially red hue and higher saturation and lightness values than pixels in the regions therearound; and
determining whether each highlight region corresponds to part of a red-eye feature on the basis of further selection criteria.

15. A method as claimed in claim 14, wherein a pixel in the highlight region must have a hue above about 210 or below about 10.

16. A method as claimed in claim 1, further comprising identifying a single pixel as a reference pixel for each identified pupil region.

17. A method as claimed in claim 14, further comprising identifying a single pixel as a reference pixel for each identified highlight region.

18. A method as claimed in 16, wherein the further selection criteria include determining whether there is an isolated area of correctable pixels around the reference pixel, a correctable pixel satisfying conditions of hue, saturation and/or lightness to enable a red-eye correction to be applied to that pixel.

19. A method as claimed in claim 18, including determining whether the isolated area of correctable pixels is substantially circular.

20. A method as claimed in claim 18, wherein a pixel is classified as correctable if its hue is greater than or equal to about 220 or less than or equal to about 10.

21. A method as claimed in claim 18, wherein a pixel is classified as correctable if its saturation is greater than about 80.

22. A method as claimed in claim 18, wherein a pixel is classified as correctable if its lightness is less than about 200.

23. A method of detecting red-eye features in a digital image, comprising:
determining whether there is a red-eye feature present around a reference pixel in the digital image, by determining whether there is an isolated, substantially circular area of correctable pixels around the reference pixel, a pixel being classified as correctable if it has a hue greater than or equal to about 220 or less than or equal to about 10, a saturation greater than about 80, and a lightness less than about 200.

24. A method as claimed in claim 18, including determining the extent of the isolated area of correctable pixels.

25. A method as claimed in claim 24, including identifying a circle having a diameter corresponding to the extent of the isolated area of correctable pixels and determining that a red-eye feature is present only if more than a predetermined proportion of pixels falling within the circle are classified as correctable.

26. A method as claimed in claim 25, wherein the predetermined proportion is about 50%.

27. A method as claimed in claim 18, including allocating a score to each pixel in an array of pixels around the reference pixel, the score of a pixel being determined from the number of correctable pixels in the set of pixels including that pixel and the pixels surrounding that pixel.

28. A method as claimed in claim 17, wherein the extent of the array of pixels is a predetermined factor greater than the extent of the highlight region or pupil region.

29. A method as claimed in claim 27, including identifying an edge pixel being the first pixel having a score below a predetermined threshold found by searching along a row of pixels starting from the reference pixel.

30. A method as claimed in claim 29, wherein if the score of the reference pixel is below the predetermined threshold, the search for an edge pixel does not begin until a pixel is found having a score above the predetermined threshold.

31. A method as claimed in claim 29, including
moving to an adjacent pixel in an adjacent row from the edge pixel,
moving in towards the column containing the reference pixel along the adjacent row if the adjacent pixel has a score below the threshold, until a second edge pixel is reached having a score above the threshold,
moving out away from the column containing the reference pixel along the adjacent row if the adjacent pixel has a score above the threshold, until a second edge pixel is reached having a score below the threshold.

32. A method as claimed in claim 31, including continuing identifying subsequent edge pixels in subsequent rows so as to identify the left hand edge and right hand edge of the isolated area, until the left edge and right hand edge meet or the edge of the array is reached.

33. A method as claimed in claim 32, wherein if the edge of the array is reached it is determined that no isolated area has been found.

34. A method as claimed in claim 32, including:
identifying the top and bottom rows and furthest left and furthest right columns containing at least one pixel in the isolated area;
identifying a circle having a diameter corresponding to the greater of the distance between the top and bottom rows and furthest left and furthest right columns, and a centre midway between the top and bottom rows and furthest left and furthest right columns;
determining that a red-eye feature is present only if more than a predetermined proportion of the pixels falling within the circle are classified as correctable.

35. A method as claimed in claim 25, wherein the pixel at the centre of the circle is defined as the central pixel of the red-eye feature.

36. A method as claimed in claim 18, including discounting one of two or more similar isolated areas as a red-eye feature if said two or more substantially similar isolated areas are identified from different reference pixels.

37. A method as claimed in claim 18, including discounting any non-similar isolated areas which overlap each other.

38. A method as claimed in claim 18, including determining whether a face region surrounding and including the isolated region of correctable pixels contains more than a predetermined proportion of pixels having hue, saturation and/or lightness corresponding to skin tones.

39. A method as claimed in claim 38, wherein the face region is approximately three times the extent of the isolated region.

40. A method as claimed in claim 38, wherein a red-eye feature is identified if:
more than about 70% of the pixels in the face region have hue greater than or equal to about 220 or less than or equal to about 30; and
more than about 70% of the pixels in the face region have saturation less than or equal to about 160.

41. A method of processing a digital image, comprising:
detecting red-eye features using a method as claimed in any preceding claim; and
correcting some or all of the red-eye features detected.

42. A method as claimed in claim 41, wherein the step of correcting a red-eye feature includes reducing the saturation of some or all of the pixels in the red-eye feature.

43. A method as claimed in claim 42, wherein the step of reducing the saturation of some or all of the pixels includes reducing the saturation of a pixel to first level if the saturation of that pixel is above a second level, the second level being higher than the first level.

44. A method as claimed in claim 41, wherein the step of correcting a red-eye feature includes reducing the lightness of some or all of the pixels in the red-eye feature.

45. A method of processing a digital image, comprising:
detecting a red-eye feature having an isolated area of correctable pixels using the method of claim 27;
reducing the lightness of each pixel in the isolated area of correctable pixels by a factor related to the score of that pixel.

46. A method of processing a digital image, comprising:
detecting a red-eye feature having an isolated area of correctable pixels using the method of claim 27;
reducing the lightness of each pixel in a circle substantially coincident with the isolated area of correctable pixels by a factor related to the score of that pixel.

47. Apparatus arranged to carry out the method of claim 1.

48. A computer storage medium having stored thereon a program arranged when executed to carry out the method of claim 1.

49. A digital image to which has been applied the method of claim 1.

50. (Cancelled)

51. (Cancelled)

52. A method of correcting red-eye features, using the method of claim 1.
